(19) United States
(12) Patent Application Publication
(10) Pub. No.: US 2013/0060397 A1
(43) Pub. Date: Mar. 7, 2013

(54) MANAGEMENT OF POWER DISTRIBUTION CONSTRAINTS

(71) Applicant: David John Hawkins, Stradford upon Avon (GB)

(72) Inventor: David John Hawkins, Stradford upon Avon (GB)

(73) Assignee: GENERAL ELECTRIC COMPANY, Schenectady, NY (US)

(21) Appl. No.: 13/227,138

(22) Filed: Sep. 7, 2011

(51) Int. Cl. G06F 1/32; G06F 1/28

(52) U.S. Cl. 700/296

(57) ABSTRACT

A method for managing power distribution constraints in a power distribution network can include identifying the constraints at least one of before and during a time the constraint arises, identifying meters that are supplied by a portion of the power distribution network affected by the constraints, confirming an availability of dispatchable devices accessible by the meters, sending messages to the dispatchable devices, monitoring responses generated by the dispatchable devices, determining a resolution of the constraints for a duration of the constraint and resetting each resolution at the end of each constraint.

### BACKGROUND OF THE INVENTION

The subject matter disclosed herein relates to electric power systems and more particularly to management of public power distribution constraints.

In a power distribution network, demand management is the use of various techniques by electrical power distributers to ensure that demand at any point in the network does not exceed capacity. Capacity constraints in power distribution networks arise when one or more devices on the power distribution network are causing an overload such as pulling too high a load, which can lead to overheating and/or overloading. Voltage constraints arise when high demands or high output from small scale embedded generators (SSEG) cause either low voltages or high voltages, respectively. Often times, customers are equipped with smart meters (e.g., at residential locations), and have an agreement with power distributors to control electrical distribution to the residence, such as power cycling some selected consumer appliances. By agreeing to have the devices controlled by the power distributor, the consumer can be given financial incentives such as lower off-peak rates for electricity. Such control can be planned for peak hours for example. By turning off devices to consumers with smart meters under such an agreement, demand management can be more easily achieved. Typically, a constraint will be present for a period of time during one or more days; the duration of the constraint will reflect the combined demand/generation of those customers connected through that section of the network which in almost all cases includes peaks and troughs in load.

With the advent of plug-in electric vehicles (PEVs), constraints can become a larger factor in power distribution networks. Charging stations for the PEVs can create sudden and extreme constraints in the power distribution network. Charging stations can be similar to smart meters, where power distribution can be controlled by the power distributor. However, since constraints caused by charging stations can be extreme, response to the constraints has to be more rapid compared to the response for residential smart meters. Currently, there is no system that allows response to the sudden and extreme constraints that can be caused by PEVs. There are similar issues with other electrical appliances which are expected to enter into more widespread use in the near future; these include ‘ground-to-water heat pumps’, ‘air-to-water heat pumps’, and a range of small scale embedded generators (SSEG), such as solar photovoltaics (PV).

### BRIEF DESCRIPTION OF THE INVENTION

According to one aspect of the invention, a method for managing power distribution constraints in a power distribution network, the method including identifying the constraints at least one of before and during a time the constraint arises, identifying meters that are supplied by a portion of the power distribution network affected by the constraints, confirming an availability of dispatchable devices accessible by the meters, sending messages to the dispatchable devices, monitoring responses generated by the dispatchable devices, determining a resolution of the constraints for a duration of the constraint and resetting each resolution at the end of each constraint.

According to another aspect of the invention, a computer program product managing power distribution constraints in a power distribution network is described. The computer program product can include a non-transitory computer readable medium storing instructions for causing a computer to implement a method. The method can include identifying the constraints at least one of before and during a time the constraint arises, identifying meters that are supplied by a portion of the power distribution network affected by the constraints, confirming an availability of dispatchable devices accessible by the meters, sending messages to the dispatchable devices, monitoring responses generated by the dispatchable devices, determining a resolution of the constraints for a duration of the constraint and resetting each resolution at the end of each constraint.

According to yet another aspect of the invention, a system for managing power distribution constraints in a power distribution network is described. The system can include a power distribution system, a dispatchable load database communicatively coupled to the power distribution system and a meter data management and communications system communicatively coupled to the power distribution system and the dispatchable load database.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 illustrates an exemplary system for managing power distribution network constraints.

FIG. 2 illustrates a flow chart for a method for managing public power distribution constraints in accordance with exemplary embodiments.

FIG. 3 illustrates an exemplary embodiment of a computer system that can be implemented to perform constraint management as described herein.

The detailed description explains embodiments of the invention, together with advantages and features, by way of example with reference to the drawings.

### DETAILED DESCRIPTION OF THE INVENTION

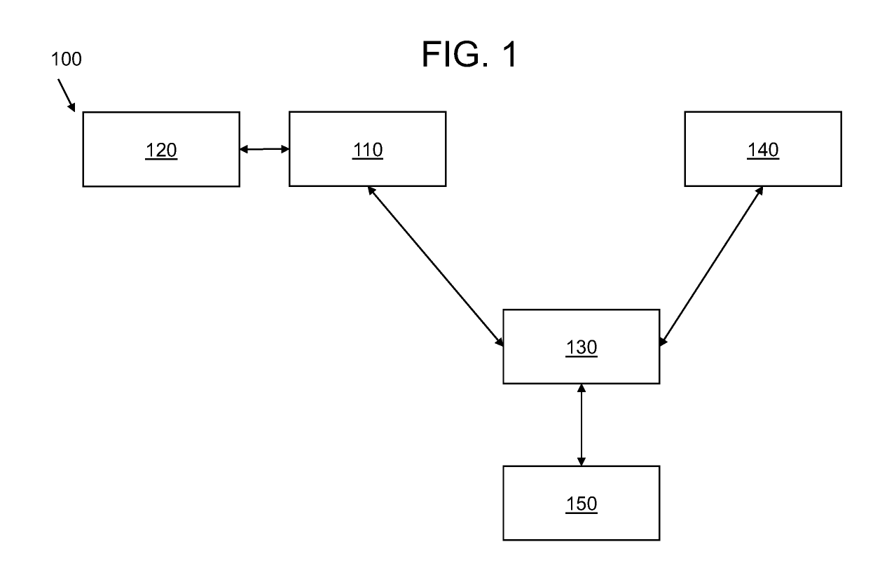

FIG. 1 illustrates an exemplary system 100 for managing power distribution network constraints. It will be appreciated that the system 100 is a part of a larger power distribution network controlled by a power utility. It will also be appreciated that the system 100 can be a low voltage (LV), medium voltage (MV), high voltage (HV), or extra high voltage (EHV) system.

In exemplary embodiments, the system 100 can include a distribution management system (DMS) or outage management system (OMS) (collectively DMS/OMS 120). A distribution management system is an electric power utility operational system responsible for collecting data from and controlling all electric power distribution devices (e.g., switches, voltage regulators, and capacitor banks) on the power distribution network. The distribution management system actively manages distribution devices to increase efficiency and reliability in the power distribution network. The distribution management system can implement various applications in order to increase reliability and efficiency including but not limited to: optimal feeder reconfiguration (OFR), fault detection and restoration (FDIR), and integrated volt/var control (IVVC). OFR finds the best choice of open (tie) points in the power network for enhanced load balancing. In order to limit the number of customers affected by an interruption due to a fault, distribution feeders in the power network are broken up into sections isolated by motorized switches or breakers. FDIR detects which section of the feeder the fault occurred, and isolates that feeder section by operating the isolating switches or breakers and restoring power to the non faulted sections. Thus, only those customers on the faulted section are affected by a power outage. IVVC maintains voltage levels and reduces var losses and provides coordinated control of the power network components such as capacitor banks and sub stations.

An outage management system can associate network configuration with customers connected to each section of the network. In this way, analysis of customer ‘no-supply calls’ and other network indications, can predict locations of network fuses or breakers that have opened upon a failure, and this helps to prioritize restoration efforts and manage resources based upon criteria such as locations of emergency facilities, size of outages, and duration of outages, provide information on the extent of outages and number of customers impacted to management, media and regulators, calculate an estimation of restoration times, manage crews assisting restoration and calculate crews necessary for a restoration. In exemplary embodiments, the DMS/OMS 120 can identify constraints in the power distribution network. In exemplary embodiments, constraints can include but are not limited to: 1) high load on network; 2) high voltages on network; 3) low voltages on network; and 4) thermal rating of network (e.g., overheating. It will be appreciated that other constraint cases may exist and the system 100 can be configured to manage these. For example, a high load constraint on the network can indicate that too many devices are currently in operation in the network. A high voltage constraint means that the voltage is too high in the power distribution network, possibly due to high SSEG output. A low voltage constraint means the voltage supplied in power distribution is too low. An overheating constraint means that there is overheating in the power distribution network, possibly due to a high, but not excessive, load over a long period. In exemplary embodiments, regardless of the constraint, the DMS/OMS 120 can indentify the constraint and as discussed further herein, remedial measures can be taken to relieve the constraint. In addition to the applications described herein, the DMS/OMS can include applications to monitor the constraints and send messages to manage the constraints.

In exemplary embodiments, the system 100 can further include a dispatchable load database (DLD) 110 coupled to the DMS/OMS 120. As further described herein, the DLD 110 includes a description of the dispatchable devices (both load and generation devices) in the system 100. The devices included in the DLD are those devices that can be remotely controlled such as consumer appliances. As described herein, the dispatchable devices can also include PEVs. As such, dispatchable devices are those consumer devices (e.g., furnaces, air conditioners, thermostats, space heaters, washing machines and dryers) or PEVs that can be directly controlled by the network operator in the event of an identified constraint that is to be managed.

In exemplary embodiments, the system 100 can further include a meter data management and communications system (MDMS) 130. In exemplary embodiments, constraints can be managed by directly controlling end consumer devices (i.e., direct load control) or by sending variable power rates to end consumer devices (i.e., pricing control) to shift consumer electric power consumption behavior. As such, the system 100 can further include customer meters 150 that is coupled to and can be directly controlled by the MDMS 130. As described herein, the customer meters 150 can also represent charging stations for PEVs. The system 100 can further include customer meter and billing systems 140 coupled to the MDMS 130. It will be appreciated that examination of data for purposes of setting rates and making determinations of controlling consumer devices can be on a time line that may be too long compared to time necessary to manage a constraint. As such, in exemplary embodiments, the MDMS 130 can be configured to send messages to the customer meters 150 in immediate response to an identification of a constraint by the DMS/OMS 120. In addition, once a constraint has been managed, the MDMS 130 can report all actions to the billing systems 140 so as to assist with the determination of any rate adjustments, via the customer meter and/or billing systems 140.

As such, in exemplary embodiments, the systems and method described herein automatically identify a constraint(s) on HV, MV and LV networks. The systems and methods further automatically identify dispatchable customer or network-side devices able to assist in ameliorating each constraint. In addition, the systems and methods automatically issue a dispatch command to the MDMS 130 or DMS/OMS 120, identifying each meter 150 associated with customer-side devices and/or each network side device. The systems and methods can further track dispatch results to confirm each constraint resolution. As described further herein, the systems and methods can also track each dispatch per meter/customer to enable appropriate TSO/DSO billing/refunds/constraint payments to be made to each customer/participant. As such, energy trading for any trading period can continue as normal prior to the adjustment of the constraints i.e., (before energy trading ends, sometimes called ‘pre-gate-closure’) while performing the TSO/DSO constraint management role after energy trading ends (sometimes called ‘post-gate-closure’).

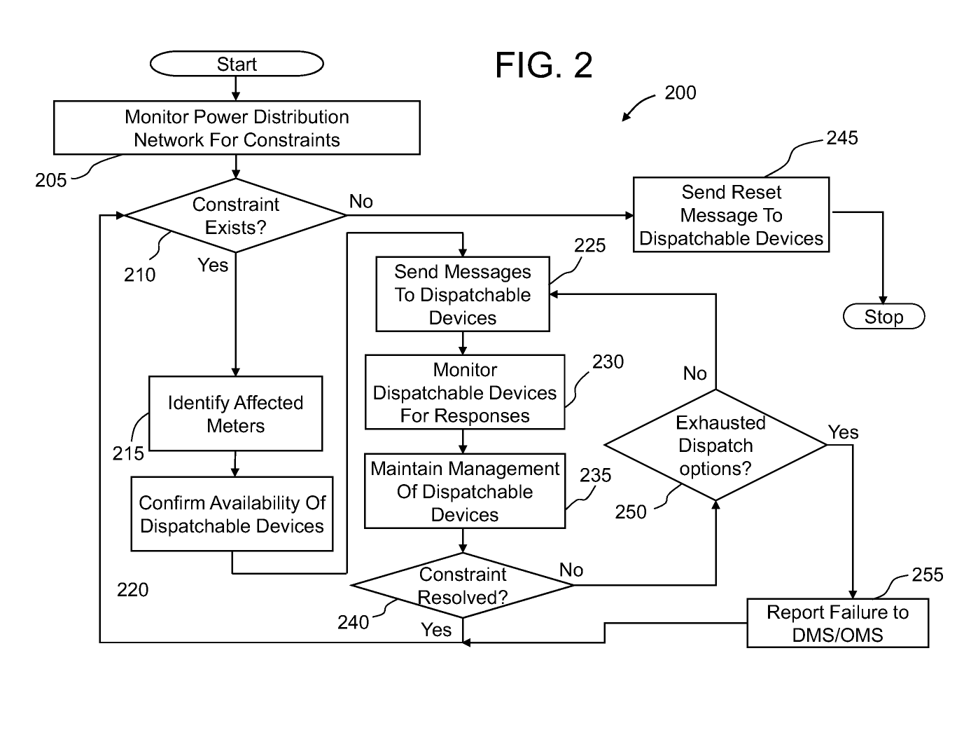

FIG. 2 illustrates a flow chart for a method 200 for managing public power distribution constraints in accordance with exemplary embodiments. At block 205 the DMS/OMS 120 monitors the power distribution network for constraints on the network, either before or during the time the constraints arise. In exemplary embodiments, the DMS/OMS 120 can collect data via a supervisory control and data acquisition (SCADA) system as known in the art. SCADA refers generally to industrial control systems, that is, computer systems that monitor and control industrial, infrastructure, or facility-based processes. At block 210, the DMS/OMS 120 can therefore make a determination if any constraints have been identified. In exemplary embodiments, the constraints can be actual constraints or constraints that have been predicted ahead of time based on anticipated/forecast conditions in the network, such as at peak time. The DMS/OMS 110 continues to monitor each network section at block 205 to confirm the existence of any constraints, including those where constraint management has already been applied. If any constraints are identified at block 210, then at block 215, the DMS/OMS 110 identifies all meters 150 “south” or downstream of the constraint, that is, all meters 150 that are supplied and therefore affected by the constraint. At block 220, the DMS/OMS 110 queries the DLD 120 to confirm the availability of dispatchable devices accessible via these selected meters 150. In exemplary embodiments, the constraint may be due to a particular group of devices. If a group of the those devices contributing to the constraint are dispatchable devices that have been registered in the DLD 120 and are accessible via the meters 150, the DMS/OMS 110 is available to make the determination via the DLD 120. At block 225, the MDMS 130 sends messages to the dispatchable devices. For example, the messages can generate a dispatch signal to instruct the dispatchable devices to reduce load or increase generation. The MDMS will also report its actions to the DMS/OMS 110 and the billing systems 140. As described herein, a goal of the system 100 is to provide demand and constraint management in the system 100. As such, the messages may indicate that the dispatchable devices provide generation to the system 100 or to reduce the load that the dispatchable devices create in the system 100. In other exemplary embodiments, the messages can include other instructions including but not limited to power cycling the dispatchable devices on and off. At block 230, the MDMS 130 monitors the dispatchable devices for responses. The responses can include a compliance with the message. The DMS/OMS 110 or MDMS 130 can therefore make a determination whether any further remedial action is necessary to manage the constraint (e.g., send additional messages to additional dispatchable devices). At block 235, the MDMS 130 can maintain the management of the dispatchable devices. At block 240, the DMS/OMS 110 can monitor the network to make a determination whether or not the constraint has been resolved. If the constraint is not resolved at block 240, then the MDMS 130 can identify additional dispatch options at block 250 and send further dispatch instructions at block 225 as required. In no further dispatch options are available and the constraint remains unresolved, the MDMS 130 can report failure at block 255 to the DMS/OMS 110: this gives the DMS/OMS 110 notification of failure and an opportunity to affect other remedies such as network reconfiguration via DMS/OMS 110. If the constraint no longer exists at block 210, then the MDMS 130 can send a reset message at block 245 to the dispatchable devices that have been under the management of the MDMS 130 in response to the constraint identified by the DMS/OMS 110.

As described herein, operational metering data can be exchanged between the DMS/OMS 110 and the MDMS 130 in immediate response to constraints in the power distribution network. In addition, energy trading can be facilitated by exchanging revenue data between the MDMS 130 and the customer meter and billing systems 140 and between the MDMS 130 and the customer meters 150. As such, energy trading and network constraint management are able to co-exist without conflict by ensuring that energy trading takes place up to the closing of the energy trading market for any trading period, while network constraint management takes place only in the period after the energy trading market closes, up to ‘real time’.

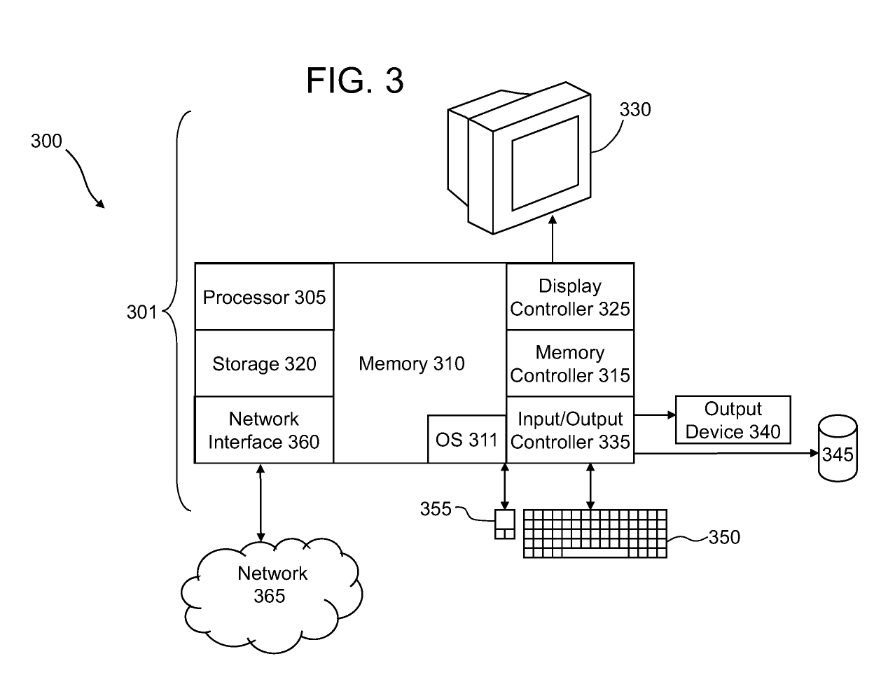

The systems and methods described herein can implement software applications that can be distributed over the various components of the system 100 including but not limited to the DMS/OMS 110 and the MDMS 130. The applications can work in conjunction to implement the method 200, for example. The several components of the system 100 described herein, such as the DMS/OMS 110 and the MDMS 130 can implement computer systems to perform the method 200, for example. As such, the software applications described herein can reside on one or more of the components of the system 100. The meters 150 can also advantageously include a computer system. In addition, the various components can communicate over various wired or wireless networks. FIG. 3 illustrates an exemplary embodiment of a computer system 300 that can be implemented to perform constraint management as described herein. The methods described herein can be implemented in software (e.g., firmware), hardware, or a combination thereof. In exemplary embodiments, the methods described herein are implemented in software, as an executable program, and is executed by a special or general-purpose digital computer, such as a personal computer, workstation, minicomputer, or mainframe computer. The system 300 therefore includes general-purpose computer 301.

In exemplary embodiments, in terms of hardware architecture, as shown in FIG. 3, the computer 301 includes a processor 305, memory 310 coupled to a memory controller 315, and one or more input and/or output (I/O) devices 340, 345 (or peripherals) that are communicatively coupled via a local input/output controller 335. The input/output controller 335 can be, but is not limited to, one or more buses or other wired or wireless connections, as is known in the art. The input/output controller 335 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 305 is a hardware device for executing software, particularly that stored in memory 310. The processor 305 can be any custom made or commercially available processor, a central processing unit (CPU), an auxiliary processor among several processors associated with the computer 301, a semiconductor based microprocessor (in the form of a microchip or chip set), a macroprocessor, or generally any device for executing software instructions.

The memory 310 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 310 may incorporate electronic, magnetic, optical, and/or other types of storage media. Note that the memory 310 can have a distributed architecture, where various components are situated remote from one another, but can be accessed by the processor 305.

The software in memory 310 may include one or more separate programs, each of which comprises an ordered listing of executable instructions for implementing logical functions. In the example of FIG. 3, the software in the memory 310 includes the constraint management methods described herein in accordance with exemplary embodiments and a suitable operating system (OS) 311. The OS 311 essentially controls the execution of other computer programs, such the constraint management systems and methods as described herein, and provides scheduling, input-output control, file and data management, memory management, and communication control and related services.

The constraint management methods described herein may be in the form of a source program, executable program (object code), script, or any other entity comprising a set of instructions to be performed. When a source program, then the program needs to be translated via a compiler, assembler, interpreter, or the like, which may or may not be included within the memory 310, so as to operate properly in connection with the OS 311. Furthermore, the constraint management methods can be written as an object oriented programming language, which has classes of data and methods, or a procedure programming language, which has routines, subroutines, and/or functions.

In exemplary embodiments, a conventional keyboard 350 and mouse 355 can be coupled to the input/output controller 335. Other output devices such as the I/O devices 340, 345 may include input devices, for example but not limited to a printer, a scanner, microphone, and the like. Finally, the I/O devices 340, 345 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The system 300 can further include a display controller 325 coupled to a display 330. In exemplary embodiments, the system 300 can further include a network interface 360 for coupling to a network 365. The network 365 can be an IP-based network for communication between the computer 301 and any external server, client and the like via a broadband connection. The network 365 transmits and receives data between the computer 301 and external systems. In exemplary embodiments, network 365 can be a managed IP network administered by a service provider. The network 365 may be implemented in a wireless fashion, e.g., using wireless protocols and technologies, such as WiFi, WiMax, etc. The network 365 can also be a packet-switched network such as a local area network, wide area network, metropolitan area network, Internet network, or other similar type of network environment. The network 365 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 301 is a PC, workstation, intelligent device or the like, the software in the memory 310 may further include a basic input output system (BIOS) (omitted for simplicity). The BIOS is a set of essential software routines that initialize and test hardware at startup, start the OS 311, and support the transfer of data among the hardware devices. The BIOS is stored in ROM so that the BIOS can be executed when the computer 301 is activated.

When the computer 301 is in operation, the processor 305 is configured to execute software stored within the memory 310, to communicate data to and from the memory 310, and to generally control operations of the computer 301 pursuant to the software. The constraint management methods described herein and the OS 311, in whole or in part, but typically the latter, are read by the processor 305, perhaps buffered within the processor 305, and then executed.

When the systems and methods described herein are implemented in software, as is shown in FIG. 3, the methods can be stored on any computer readable medium, such as storage 320, for use by or in connection with any computer related system or method.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In exemplary embodiments, where the constraint management methods are implemented in hardware, the constraint management methods described herein can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Technical effects include the ability to manage both energy trading and constraints without any interference between the two data paths. Energy trading and network constraint management are able to co-exist without conflict by ensuring that energy trading takes place up to the closing of the energy trading market, while network constraint management takes place only in the period after the energy trading market closes, up to ‘real time’. The systems and methods described herein can accommodate both large scale imbalances (e.g. between generation and overall demand), and also a wide range of network imbalances (constraints) by targeting specific dispatchable devices. As such, the systems and methods described herein avoid and/or defer unnecessary capital expenditure on network reinforcement.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method for managing power distribution constraints in a power distribution network, the method comprising:
identifying the constraints at least one of before and during a time the constraint arises;
identifying meters that are supplied by a portion of the power distribution network affected by the constraints;
confirming an availability of dispatchable devices accessible by the meters;
sending messages to the dispatchable devices;
monitoring responses generated by the dispatchable devices;
determining a resolution of the constraints for a duration of the constraint; and
resetting each resolution at the end of each constraint.

2. The method as claimed in claim 1 further comprising in response to a determination that the constraints have been resolved, sending a reset message to the dispatchable devices.

3. The method as claimed in claim 1 wherein the dispatchable devices are devices that can be directly controlled to manage the constraints.

4. The method as claimed in claim 1 wherein the dispatchable devices are at least one of plug-in electrical vehicles and small scale embedded generators (SSEG).

5. The method as claimed in claim 1 wherein the meters are at least one of incorporated in electric vehicle charging stations and associated with small scale embedded generators (SSEG).

6. The method as claimed in claim 1 wherein the messages sent to the dispatchable devices are load dispatch signals that instruct at least one of the dispatchable devices and voltage target signals to appropriate dispatchable devices.

7. The method as claimed in claim 6 wherein the dispatch load signals instruct the dispatchable devices to at least one of reduce a load and increase load generation, and dispatch voltage signals to instruct the dispatchable devices to at least one of reduce a target voltage or increase a target voltage or change target power factor.

8. The method as claimed in claim 1 further comprising monitoring dispatch instructions to the meters to determine a revenue stream.

9. The method as claimed in claim 8 further comprising determining incentives associated with the meters and based on the dispatch instructions to the meters.

10. The method as claimed in claim 9 wherein the incentives can include at least one of billing rates, refunds and constraint payments.

11. A computer program product managing power distribution constraints in a power distribution network, the computer program product including a non-transitory computer readable medium storing instructions for causing a computer to implement a method, the method comprising:
identifying the constraints at least one of before and during a time the constraint arises;
identifying meters that are supplied by a portion of the power distribution network affected by the constraints;
confirming an availability of dispatchable devices accessible by the meters;
sending messages to the dispatchable devices;
monitoring responses generated by the dispatchable devices;
determining a resolution of the constraints for a duration of the constraint; and
resetting each resolution at the end of each constraint.

12. The computer program product as claimed in claim 11 wherein the method further comprises in response to a determination that the constraints have been resolved, sending a reset message to the dispatchable devices.

13. The computer program product as claimed in claim 11 wherein the dispatchable devices are devices that can be directly controlled to manage the constraints.

14. The computer program product as claimed in claim 13 wherein the dispatchable devices are at least one of plug-in electrical vehicles and small scale embedded generators (SSEG).

15. The computer program product as claimed in claim 14 wherein the meters are at least one of incorporated in electric vehicle charging stations and associated with small scale embedded generators (SSEG).

16. The computer program product as claimed in claim 11 wherein the messages sent to the dispatchable devices are load dispatch signals that instruct the dispatchable devices to at least one of reduce a load and increase load generation.

17. The computer program product as claimed in claim 11 wherein the method further comprises:
monitoring dispatch instructions to the meters to determine a revenue stream; and
determining incentives associated with the meters and based on the dispatch instructions to the meters,
wherein the incentives can include at least one of billing rates, refunds and constraint payments.

18. A system for managing power distribution constraints in a power distribution network, the method comprising:
a power distribution system;
a dispatchable load database (DLD) communicatively coupled to the power distribution system; and
a meter data management and communications system (MDMS) communicatively coupled to the power distribution system and the DLD.

19. The system as claimed in claim 18 wherein the power distribution system is at least one of a distribution management system and an outage management system.

20. The system as claimed in claim 18 further comprising a process accessible by at least one of the power distribution system, the DLD and the MDMS, the process configured for:
identifying the constraints at least one of before and during a time the constraint arises;
identifying meters that are supplied by a portion of the power distribution network affected by the constraints, the meters being communicatively coupled to the MDMS;
confirming an availability of dispatchable devices accessible by the meters, the dispatchable devices being registered in the DLD;
sending messages to the dispatchable devices;
monitoring responses generated by the dispatchable devices; and
determining a resolution of the constraints for a duration of the constraint; and
resetting each resolution at the end of each constraint.
